(19) United States
(12) Patent Application Publication
(10) Pub. No.: US 2007/0093145 A1
(43) Pub. Date: Apr. 26, 2007

(54) Elastic contact

(76) Inventor: Shih-Fu Wei, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/257,990

(22) Filed: Oct. 26, 2005

(51) Int. Cl. H01R 13/24

(52) U.S. Cl. 439/824

(57) ABSTRACT

An elastic contact that can adjust the angle and can bend between the electrical connector and the mating connector, so that good contact is constantly maintained. The elastic contact is installed into an electrical connector and electrical connects with a mating connector. The elastic contact includes a body portion, an elastic arm and a contact portion. A solder terminal extends downward from the body portion. The elastic arm bends upward and extends from one side of the body portion. The contact portion is formed on an end of the elastic arm, and exposes the top of the electrical connector, wherein the top of the contact portion forms a curved surface having the shape of a bullet.

### BACKGROUND OF THE INVENTION

1. Field of the Invention

The present invention relates to a contact for electrically connecting a mating connector installed in an electrical connector, and especially relates to an elastic contact that can shrink.

2. Background of the Invention

Referring to FIG. 1, a 3-dimensional (3-D) image of an electrical connector and a mating connector of prior art is shown. The electrical connector is a plug-type electrical connector, usually applied to devices such as mobile phones, personal digital assistants and chargers, etc. for transmitting power, a voice signal or an image signal. The electrical connector 8 holds a plurality of elastic contacts, each of the elastic contacts has a contact terminal 82 which is the shape of a slab and has a curved front edge appearing from the front of the electrical connector 8. The electrical connector 8 operates in coordination with the mating connector 9, and the mating connector 9 has a plurality of flat surface contacts 92 which are fixed.

Referring to FIG. 2, an enlarged 3-D image of a contact terminal of an elastic contact of prior art is shown. The elastic contact of the contact terminal is formed by stamping a metallic board. In the stamping process, due to the cutting tool of the stamp, some of the edges on the contact terminal of the elastic contact are not formed smoothly. The unsmooth edges do not transmit signals well. If the stamping process does produce the desired smooth elastic contact terminal, the shape of the contact terminal is like the one shown in FIG. 2. As can be seen, there is a cutting surface 84 and cutting angles on both sides 86 and 88 are formed on each of the contact terminals.

During use, the electrical connector 8 connects with the mating connector. Inevitably this leads to a situation in which the contact terminal become slanted and bent. This often means that the elastic contact cannot maintain front contact with the mating connector. When this occurs, if the contact terminal 82 is bent, when the cutting angles 86 and 88 contact the flat surface contact 92 of the mating connector 9, noise will be produced during transmission. The noise, for sounds and images, often produces a large impedance and affects the quality of communication.

In addition, in order for the elastic contact of the prior art to be able to continually receive a deforming force when the elastic contact is connected, it often uses very high strength materials, such as BeCu, to enhance the hardness and strength of the contacts. Thereby the contacts will be capable of enduring more stress and will conform to the requirements for increased elasticity. However, BeCu is expensive, and the hardness is higher. Not only does this raise the cost of the contacts, but it also increases the difficulty of the manufacturing process.

Therefore, the elastic contact of the prior art, in practical application, is obviously inconvenient and has several defects that can be improved upon.

### SUMMARY OF THE INVENTION

An object of the present invention is to provide an elastic contact that can adjust the slanting and bending when the electrical connector and the mating connector are connected. Thereby, noise is reduced, and a good contact is established and maintained so that a high quality signal is ensured.

The elastic contact of the present invention installed into an electrical connector, and is used to electrically connected to a mating connector. The electrical connector includes a body portion, having a soldered terminal extending downward from the body portion; an elastic arm is bending upward and extending from one side of the body portion; a contact portion formed on one end of the elastic arm, and exposing a top of the electrical connector, wherein the top of the contact portion forms a curved surface having the shape of a bullet.

The various objects and advantages of the present invention will be more readily understood from the following detailed description when read in conjunction with the appended drawing, in which:

### BRIEF DESCRIPTION OF DRAWING

These and other features, aspects, and advantages of the present invention will become better understood with regard to the following description, appended claims, and accompanying drawings, wherein:

FIG. 1 shows a 3-D image of an electrical connector and a mating connector of the prior art;

FIG. 2 shows an enlarged 3-D image of a contact terminal of an elastic contact of the prior art;

FIG. 3 shows a front view of an elastic contact and a metallic belt according to the present invention;

FIG. 3A shows a locally enlarged view of region 3A of the contact portion in FIG. 3;

FIG. 3B shows an enlarged lateral view of region 3A of a contact portion in FIG. 3; and

FIG. 4 shows a locally 3-D image of an elastic contact according to the present invention.

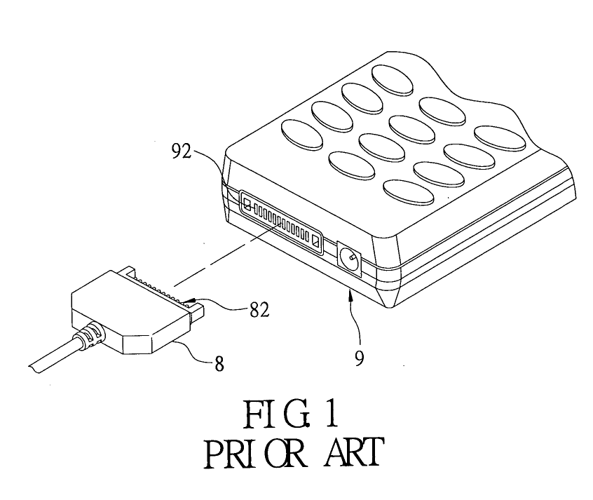

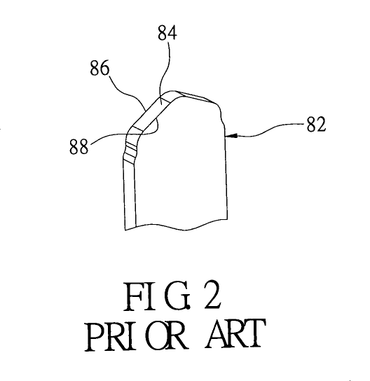

### DETAILED DESCRIPTION OF THE INVENTION

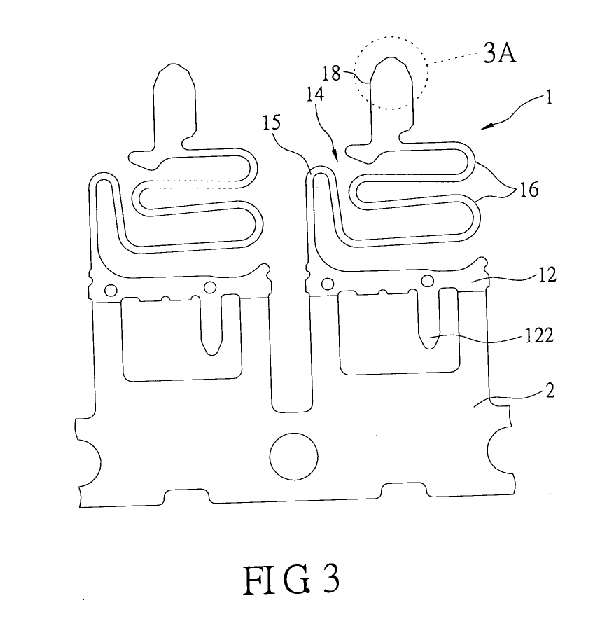

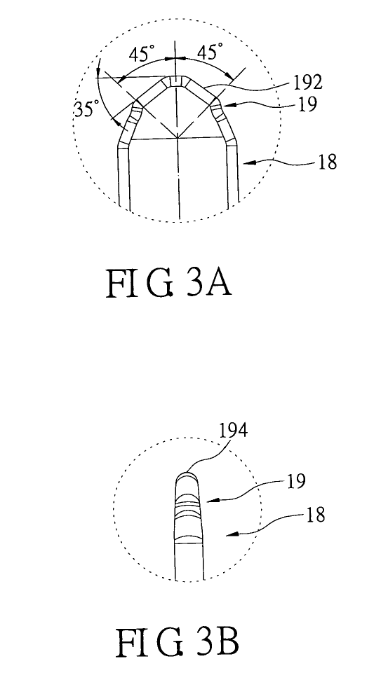

Reference is made to FIG. 3, which is a front view of an elastic contact and a metallic belt according to the present invention. The present invention provides an elastic contact 1 installed in an electrical connector (not shown in the figure). The elastic contact 1 includes a body portion 12, an elastic arm 14 elastically extending from the body portion 12, and a contact portion 18 formed on the end of the elastic arm 14.

The body portion 12 extends downward to contact a solder terminal 122, that is used to electrically connect to an electrical wire from the electrical connector. The elastic arm 14 provides an elastic force to the contact portion 18, used to withstand a pressure made when connecting to the mating connector. In the preferred embodiment of the present invention, the elastic arm 14 comprises a longitudinal bending portion 15 extending upward from a terminal of the body portion 12. Two latitudinal bending portions 16 connect to a terminal of the longitudinal bending portion 15. The elastic arm 14 of the present invention provides an elastic force to multiple directions that props up the mating connector. The longitudinal bending portion 15 provides an elastic force to a side direction. Two latitudinal bending portions 16 are winding connecting, and are used to provide an elastic force in a longitudinal direction.

The contact portion 18 formed on the end of the elastic arm 14, and exposes a top of the electrical connector, wherein the top portion 19 of the contact portion 18 (shown in FIG. 3A) is formed as a curved surface having the shape of a bullet.

Referring to FIGS. 3A and 3B, FIG. 3A is a locally enlarged view of a contact portion according to the part “3A” in FIG.3. FIG. 3B is an enlarged lateral view of a contact portion according to the part “3A” in FIG.3. The top portion 19 of the contact portion 18 has a bullet-shaped curved surface, that is to say, the top portion 19 comprises a front curved surface 192 (referring to FIG. 3A) formed along a front of the contact portion 18, and a lateral curved surface 194 (referring to FIG. 3B) formed along a lateral side of the contact portion 18. Furthermore, the front curved surface 192 and the lateral curved surface 194 can adjust the angle formed between the electrical connector and the mating connector, and providing good contact.

According FIG.3A, when the electrical connector swings sideways, the front curved surface 192 of top portion 19 responds appropriately, and utilizes an elastic force of the elastic arm 14, so that the electrical connector can maintain good contact with a flat surface connecting terminal of the mating connector.

According FIG.3B, when the electrical connector swings up and down, the lateral curved surface 194 of top portion 19 responds appropriately, and utilizes the elastic force of the elastic arm 14, so that the electrical connector can maintain good contact with the flat surface connecting terminal of the mating connector.

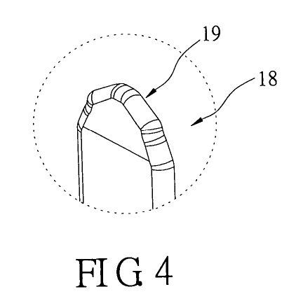

Referring to FIG. 4, that shows a close-up 3-D image of an elastic contact according to the present invention. FIG. 4 shows the top portion 19 of the contact portion 18 that has a smooth curved surface, thereby the present invention overcomes the problem of noise produced due to the bad contact suffered in the prior art. The top portion 19 of the elastic contact 1 of the present invention can maintain stable contact with the flat surface connecting terminal of the mating connector.

Furthermore, the top portion 19 forms a linear section of a preset length from the front curved surface to both sides of the front curved surface (shown as the location of the front curved surface 192 in FIG. 3A), an included angle between the linear section and the level of the contact portion is between 30°˜40°. In the preferred embodiment of the present invention, the included angle is 35°. When the contact portion 18 is at an angle, the linear section has a larger contact area with the connecting terminal of the mating connector. Moreover, the linear section co-operating with the elastic arm 14 can produce a force to withstand continual pressure caused by the slanting of the connector. Moreover, an angle from a center line to both sides of the curved surface has the same shape of a bullet as the top portion 19 and the contact portion 18 is greater than 45°.

Regarding the manufacturing method of the top portion 19 of the present invention, the elastic contact 1 is formed by stamping twice the curved surface of the contact portion 18. Each stamping cuts and forms a half curve on the contact portion 18. After it has been stamped twice, the curved shape is formed. Next, the mold procedure forms the surface and the top of contact portion 18 giving it a bullet-shaped curve and burnished surface. The manufacturing method of the top portion 19 is not key point in the present invention, so it will not be discussed in further detail.

To sum up, the elastic arm of present invention provides greater elasticity due to its shaped design, the present invention achieves the same characteristics as BuCu, is much cheaper than BuCu, but also, because it is softer than BuCu, forming the bullet-shape curved surface in the manufacturing process is easy.

Due to the bullet-shape curved surface of the top portion, the elastic contact of the present invention can be adjusted so that the angle and bending between the electrical connector and the mating connector, won't produce noise, therefore providing stable contact, and ensuring that signal are transmitted well.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An elastic contact installed into an electrical connector for electrically connecting with a mating connector, comprising:
a body portion, having a solder terminal extending downward from the body portion;
an elastic arm bending upward and extending from one side of the body portion; and
a contact portion, exposing the top of the electrical connector and formed on an end of the elastic arm, wherein the contact portion has a bullet-shaped top portion, the bullet-shaped top portion defining a curved surface having both an arcuate frontal contour and an arcuate side contour for adaptively maintaining contact with the mating connector upon deflection of the elastic arm.

2. The elastic contact as in claim 1, wherein the elastic arm includes an longitudinal bending portion extending upward from one side of the body portion, and at least two latitudinal bending portion connecting one end of the longitudinal bending portion.

3. The elastic contact as in claim 1, the bullet-shaped curved surface of the contact portion including a front curved surface formed along the front of the elastic contact, and a lateral side curved surface extending transversely therefrom.

4. The elastic contact as in claim 3, wherein the top of the contact portion forms a linear section of preset length from the front curved surface to the both sides of front curved surface.

5. The elastic contact as in claim 4, wherein an angle between the linear section and level projection of the contact portion is between 30°˜40°.

6. The elastic contact as in claim 1, wherein an angle from the center line to both sides of the bullet-shaped curved surface of the top portion of the contact portion is greater than 45°.

7. An elastic contact installed into an electrical connector for electrically connecting with a mating connector, comprising:
a body portion, having a solder terminal extending downward from the body portion;
an elastic arm bending upward and extending from one side of the body portion, the elastic arm including first bent portion extending longitudinally upward from the body portion and a plurality of second bent portions laterally offset therefrom to extend along a lateral direction over the body portion, each of the second bent portions being transversely oriented relative to the first bent portion; and
formed on an end of the elastic arm, wherein the contact portion has a bullet-shaped portion terminating at a curved surface.

8. The elastic contact as in claim 7, wherein the bullet-shaped top portion defines a curved surface having both an arcuate frontal contour and an arcuate side contour for adaptively maintaining contact with the mating connector upon deflection of the elastic arm.

9. The elastic contact as in claim 8, wherein the top of the contact portion forms a linear section of preset length from the front curved surface to the both sides of front curved surface.

10. The elastic contact as in claim 9, wherein an angle between the linear section and a level projection of the contact portion that is between 30°˜40°.

11. The elastic contact as in claim 7, wherein an angle from the center line to both sides of the bullet-shaped curved surface of the top portion of the contact portion is greater than 45°.
